(19) United States
(12) Patent Application Publication
(10) Pub. No.: US 2014/0366055 A1
(43) Pub. Date: Dec. 11, 2014

(54) TERMINAL, A SET INFORMATION INPUTTING METHOD OF AN ELECTRONIC APPARATUS, A COMPUTER READABLE INFORMATION STORAGE MEDIUM, AND AN ELECTRONIC APPARATUS

(71) Applicant: Kabushiki Kaisha Toshiba, Tokyo (JP)

(72) Inventor: Masatoshi Murakami, Hamura-shi (JP)

(73) Assignee: Kabushiki Kaisha Toshiba, Tokyo (JP)

(21) Appl. No.: 14/260,136

(22) Filed: Apr. 23, 2014

Related U.S. Application Data
(63) Continuation of application No. PCT/JP2013/065820, filed on Jun. 7, 2013.

(51) Int. Cl. H04N 21/4223; H04N 1/00; H04N 21/41; H04N 21/258

(52) U.S. Cl. CPC H04N 21/4223; H04N 21/25816; H04N 1/00244; H04N 1/00283; H04N 21/4108
USPC 725/30

(57) ABSTRACT

According to one embodiment, an analyzer analyzes a two-dimensional code including device information and an address of a predetermined server. A communicator establishes communications with the predetermined server and sends the device information to the server. A guide-image processor causes a display device to display a guide image based on information received from the server. Then user can input set information necessary to the display. A set-information processor supplies input log-in set information to the server to cause the log-in set information to be registered in the server.

### CROSS REFERENCE TO RELATED APPLICATIONS

This application is a Continuation Application of PCT Application No. PCT/JP2013/065820, filed Jun. 7, 2013, the entire contents of which are incorporated herein by reference.

### FIELD

Embodiments described herein relate generally to a terminal, a log-in set information inputting method of an electronic apparatus, a computer-readable information storage medium, and an electronic apparatus.

### BACKGROUND

An electronic apparatus such as a television receiver or a personal computer can communicate with an external server. In order to establish these communications, it is necessary to perform an initial set operation. In the initial set operation, it is necessary to input an address (e.g., a uniform resource locator (URL)) necessary to connect the electronic apparatus and the server, and set an account for a user who uses the electronic apparatus. Also, in order for the electronic apparatus to selectively communicate with a plurality of servers, it is necessary to input a plurality of addresses.

However, in the case where the above operation is manually performed on the electronic apparatus, it is troublesome for the user, and there is a case where an error is made in input operation. In addition, it takes long time to perform the operation. Therefore, it has been required to improve such a kind of operation method. In order to do so, the following methods have been proposed:

A camera sends camera ID and an URL of an associated server with short-distance wireless to a television receiver. The television receiver accesses the associated server using the camera ID and the URL of the associated server. Then, the television receiver becomes able to acquire, from the associated server, image data uploaded from the camera.

In the above method, the user does not need to manually input the camera ID or the URL of the associated server to the television receiver. This can thus reduce the troublesomeness for the user, the possibility of occurrence of an error in input operation and the waste of time.

Furthermore, as a method for reducing the troublesome of operations, there is provided a method using a memory storing in advance data to be input to an electronic apparatus. If an electronic apparatus is designed to read data from a memory, it can reduce the possibility of occurrence of an error in inputting data by the user.

In a large number of conventional methods of improving operations, an electronic apparatus is set in advance. However, setting of an electronic apparatus is accompanied with a number of operations which require, especially, manual inputting by the user. It is therefore required to reduce the burden of the operation on the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view for use in explaining a relationship between a service offering server, a portable terminal and a television receiver to which an embodiment is applied;

FIG. 2 is a view showing an example of an image in which a two-dimensional code is displayed on a screen of the television receiver in the embodiment;

FIG. 3 is a view showing an example of input entries for use in inputting log-in set information, which is displayed on the screen of the television receiver or a portable terminal in the embodiment;

FIG. 4 is a view showing an example of input log-in set information in the embodiment;

FIG. 5 is a view showing an example of log-in set information input as additional data in the embodiment;

FIG. 6 is a view for use in explaining a flow of information between the television receiver, the portable terminal and the service offering server when log-in set information is set, in the embodiment;

FIG. 7 is a flowchart of an example of an operation procedure in the television receiver in the embodiment;

FIG. 8 is a flowchart of an example of an operation procedure in the portable terminal in the embodiment;

FIG. 9 is a flowchart of an example of an operation procedure in the service offering server in the embodiment;

FIG. 10 is a flowchart of another example of the operation procedure in the service offering server in the embodiment;

FIG. 11 is a view for use in explaining the flow information between the television receiver, the portable terminal and the service offering server when the television receiver logs in to in the embodiment;

FIG. 12 is a view showing an example of a structure of the television receiver in the embodiment;

FIG. 13 is a view showing an example of a structure of the portable terminal in the embodiment;

FIG. 14 is a view showing an example of an image displayed on a screen of the portable terminal;

FIG. 15 is a view showing an example of an image displayed on the screen of the television receiver when the television receiver is made to communicate with the service offering server, and logs in using family ID; and

FIG. 16 is a view showing an image displayed on the screen of the television receiver when the television receiver is made to communicate with a net, and logs in using personal ID.

### DETAILED DESCRIPTION

Various embodiments will be described hereinafter with reference to the accompanying drawings.

In general, according to one embodiment, there are provided a portable terminal, a log-in set information inputting method of an electronic apparatus, a computer-readable information storage medium, and an electronic apparatus, which enable setting to be easily carried out.

According to an embodiment of the present disclosure, there are provided an image capture configured to optically image an object, a processor configured to acquire device information and a first address of a first server through the image capture, a communicator configured to send the device information to the first server, using the first address, and a display controller configured to display a guide image based on information received from the first server through the communicator, the guide image being provided as an image for enabling set information to be input, the set information being used by an electronic apparatus having the device information to log in to the first server.

The processor supplies log-in set information input using the guide image to the first server through the communicator to cause the log-in set information to be registered in the first server.

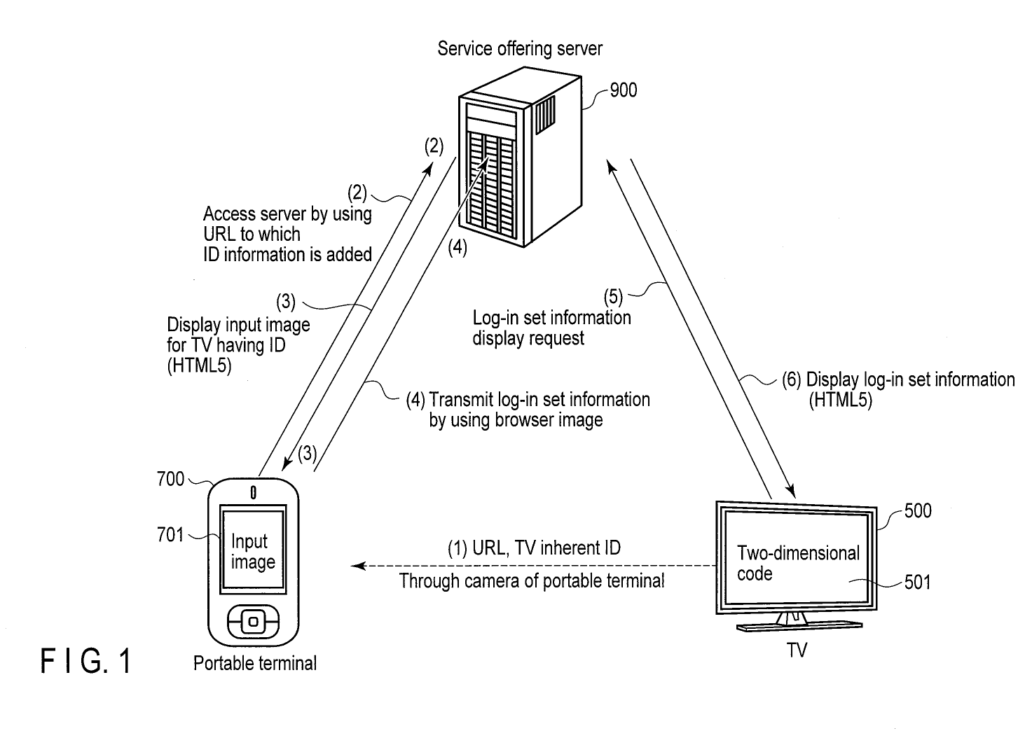

Embodiments will further be described with reference to the accompanying drawings. FIG. 1 shows a relationship between a television receiver 500, a portable terminal 700 and a service offering server 900, to which an embodiment is applied.

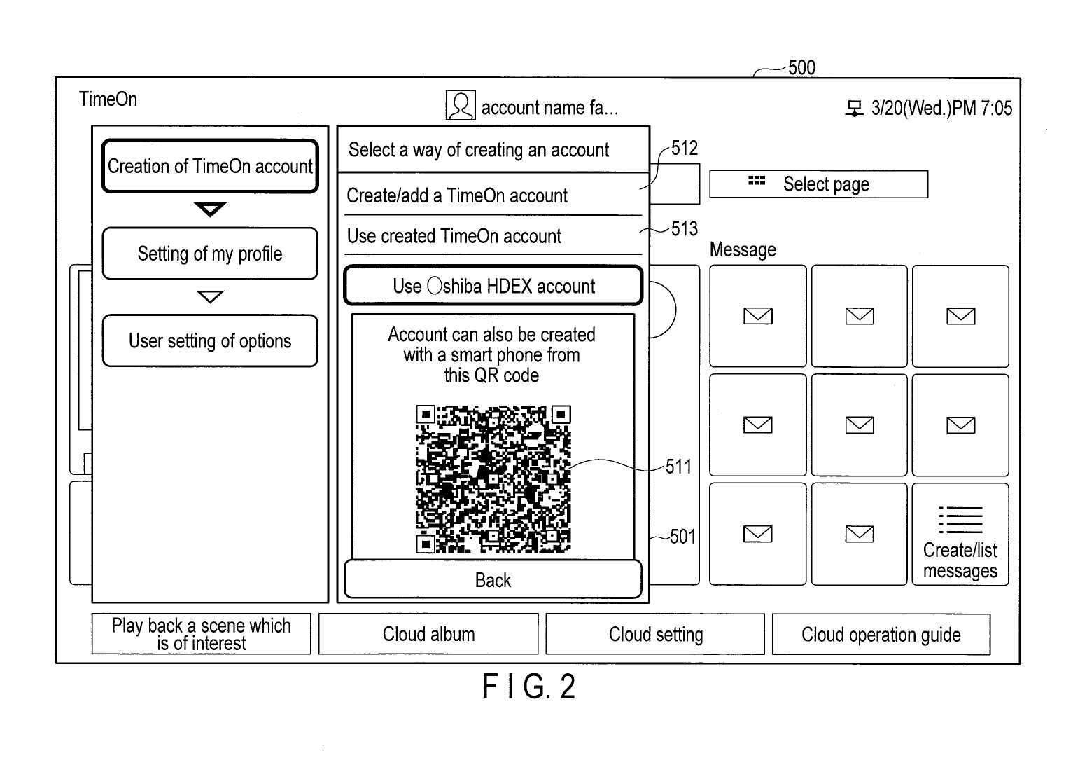

The television receiver 500 displays on a screen, a two-dimensional code (e.g., a QR code (registered trademark), characters or a figure) as an initial set image, in an initial setting (for example, when an initial set button is operated or a power supply is turned on for the first time after purchasing). The two-dimensional code is displayed, e.g., in such a way as shown in FIG. 2. In FIG. 2, 501 denotes an initial image, and 511 denotes a two-dimensional code. In the initial image 501, a message is displayed, such as the message “Account can also be created with a smart phone from this QR code”.

The two-dimensional code is a code including an address of the service offering server 900 and device information, and displayed as an initial image. The device information is identification information inherent in the television receiver 500 (which may be referred to as TV inherent ID). The address is a uniform resource locator (URL) for accessing the service offering server 900. As another example of the two-dimensional code, a URL including device information may be used.

The two-dimensional code can be read by a camera function of the portable terminal 700 (path (1) in FIG. 1). The portable terminal 700 analyzes the two-dimensional code, and accesses the service offering server 900 at the URL (path (2) in FIG. 1). At this time, the portable terminal 700 transmits the device information regarding the television receiver 500 to the service offering server 900.

The service offering server 900 recognizes the device information regarding the television receiver 500. Then, the service offering server 900 makes Hypertext Markup Language 5 (HTML 5), and send it to the portable terminal 700 (path (3) in FIG. 1).

Based on the HTML 5, the portable terminal 700 makes and displays a browser image. The browser image is a guide image for use in inputting information (log-in set information) serving as a keyword when the television receiver 500 logs in to the service offering server 900.

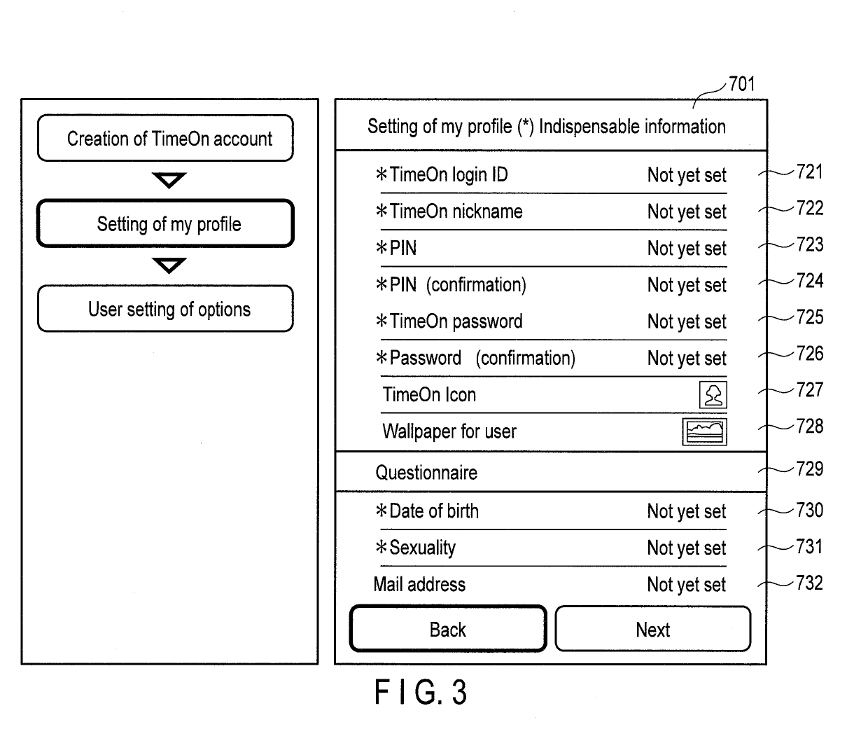

FIG. 3 shows an example of the browser image displayed on the screen of the portable terminal 700. Some entries for setting my-profile are indicated in the browser image.

At an initial set time, entries 721-732 are in non-set states (FIG. 3 shows non-set states). As entries 721-723, entries for inputting “login ID” and “nickname” of the user are present and an entry for inputting a Personal Identification Number is present as “(PIN)”. Also, an entry for inputting the Personal Identification Number for confirmation is present as “PIN (confirmation)”.

Further, an entry for inputting “password” is present, and an entry for inputting “password” for conformation is present as “password (confirmation)”.

Furthermore, there are provided an entry for inputting “icon” of the user, an entry for setting “wallpaper” of a login image, an entry for filling out a questionnaire, an entry for inputting “date of birth (birthday)”, an entry for inputting “sexuality” and an entry for inputting “mail address”.

With respect to the entries 721-723, the user can input or set information by operating the portable terminal 700. A display section of the portable terminal 700 can also be utilized as a touch type operation input section. Therefore, when the user touches a desired entry, an operation image appears which includes a plurality of keys such as alphabet key and numeric keys for use in inputting information to be set for the entry. The user selectively operates the plurality of keys for inputting information, and inputs necessary information. After inputting the necessary information, when the user operates a “Back” button, the image to be displayed returns to the image shown in FIG. 3. Next, the user touches another entry for which information is to be subsequently input, and inputs the information. The user inputs information for all entries for which information is to be input. It should be noted that “TimeOn” means that communications between the portable terminal 700 and specific service offering server 900 are established. For example, it means that the service offering server 900 offers information regarding service established by a specific manufacturer. Therefore, “TimeOn” does not have a specific meaning, and is not necessarily indispensable.

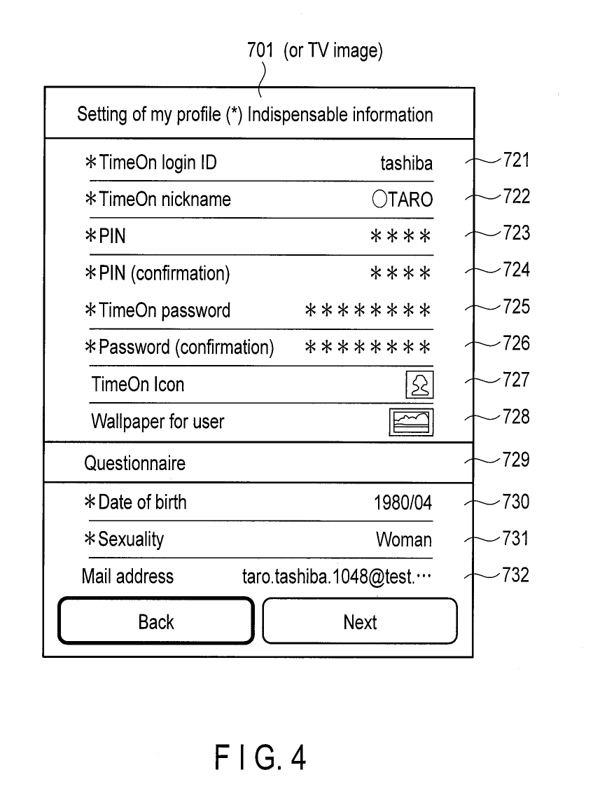

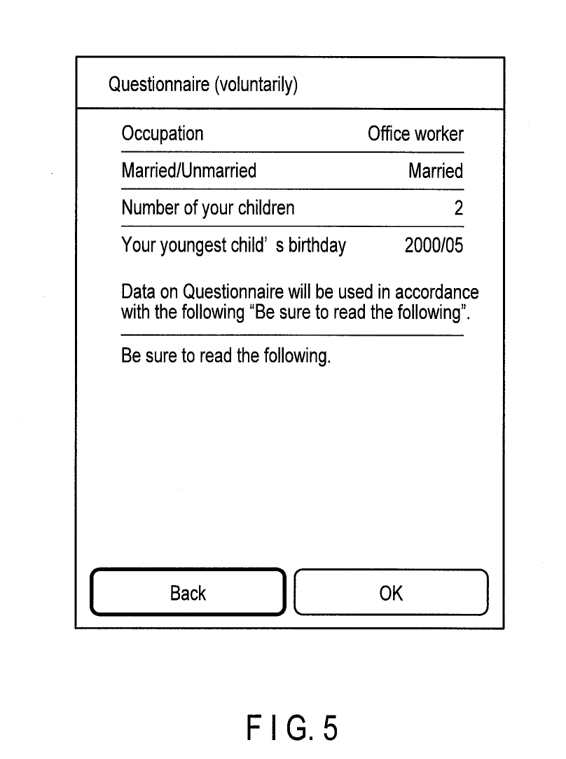

FIG. 4 shows an example of an image in which login ID and a nickname are input. FIG. 5 shows an example of an image in which a questionnaire is filled out. The image as shown in FIG. 5 appears when the entry “Questionnaire” as shown in, e.g., FIG. 4, is touched. When the “Back” button is touched as shown in FIG. 5, the image to be displayed returns to the image as shown in FIG. 4.

The following explanation is given re-referring to FIG. 1. As described above, in the embodiment, log-in set information can be set with the portable terminal 700. The log-in set information is transmitted to the service offering server 900 when a transmission button, which is displayed after a set completion button, is operated (path (4) in FIG. 1).

In the service offering server 900, the transmitted log-in set information is stored in a storage medium in association with the device information regarding the television receiver 500.

Thereby, the service offering server 900 can be logged in to using login ID, a nickname, password, etc.

Furthermore, the user can confirm the log-in set information stored in the service offering server 900. Thus, the user can request the service offering server 900 to display the log-in set information, by operating the television receiver 500. At this time, for example, the television receiver 500 can be operated by operating a specific operation button, which is set in advance, while the television receiver 500 is in an ON-state.

When the above operation is performed, the television receiver 500 starts to communicate with the service offering server 900, and makes a display request for causing the log-in set information to be displayed. Then, the service offering server 900 transmits the log-in set information to the television receiver 500. Upon receipt of the log-in set information, the television receiver 500 can display such log-in set information as shown in FIG. 4.

While viewing the log-in set information displayed by the television receiver 500, the user can confirm whether the log-in set information is correctly set or not.

As the portable terminal 700, a device having a camera function is used, such as a cell phone, a tablet, a personal assistant device (PDA) or the like. In addition, although the above explanation is given with respect to the television receiver 500, an electronic apparatus for which an initial setting needs to be performed, e.g., a personal computer, may be applied.

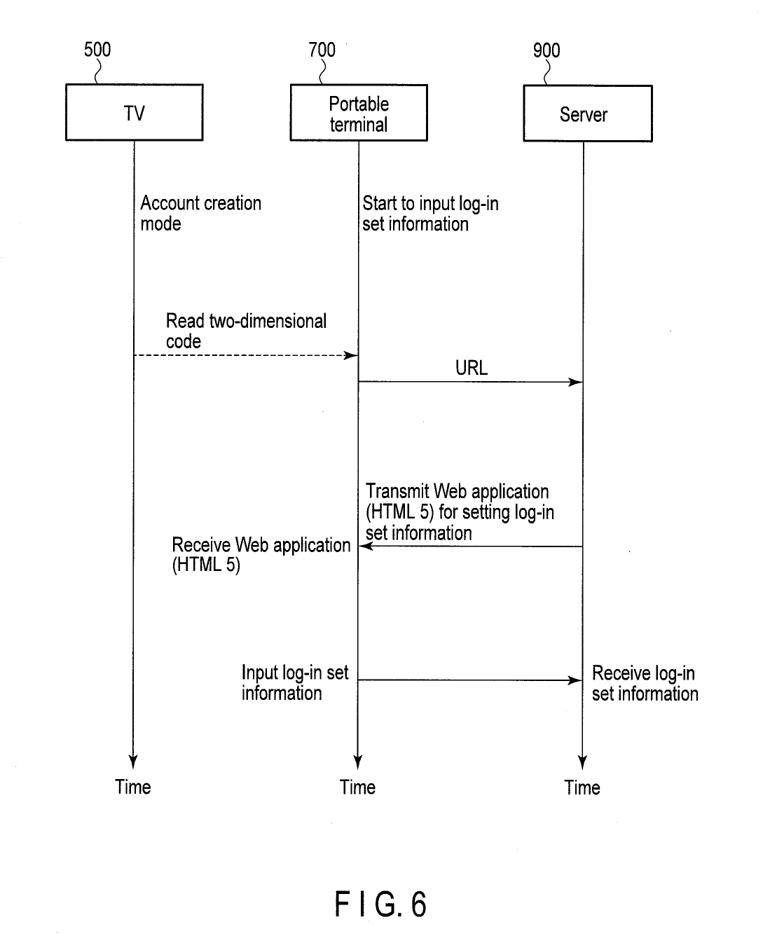

FIG. 6 shows what is transmitted and received via the paths (1)-(4) explained with reference to FIG. 1, between the television receiver 500, the portable terminal 700, and the service offering server 900, along a temporal axis.

In the television receiver 500, in an account creation mode, such a two-dimensional code as shown in FIG. 2 is displayed. The user operates the portable terminal 700 to read the two-dimensional code. The portable terminal 700 operates based on an application for a two-dimensional code processing, which is installed in advance. When the user pushes the transmission button, the portable terminal 700 establishes communications with the service offering server 900, using the URL.

Next, the service offering server 900 analyzes information included in the URL based on an application installed in advance. Then, based on the result of analysis, the service offering server 900 recognizes that setting of log-in set information associated with the television receiver 500 will start. Furthermore, the service offering server 900 transmits a Web application (HTML 5) for setting log-in set information to the portable terminal 700.

The portable terminal 700 receives the Web application (HTML 5), and as explained with reference to FIG. 3, displays a browser image for use in inputting log-in set information. In the portable terminal 700, when inputting of the log-in set information ends, the log-in set information is transmitted to the service offering server 900, and stored therein.

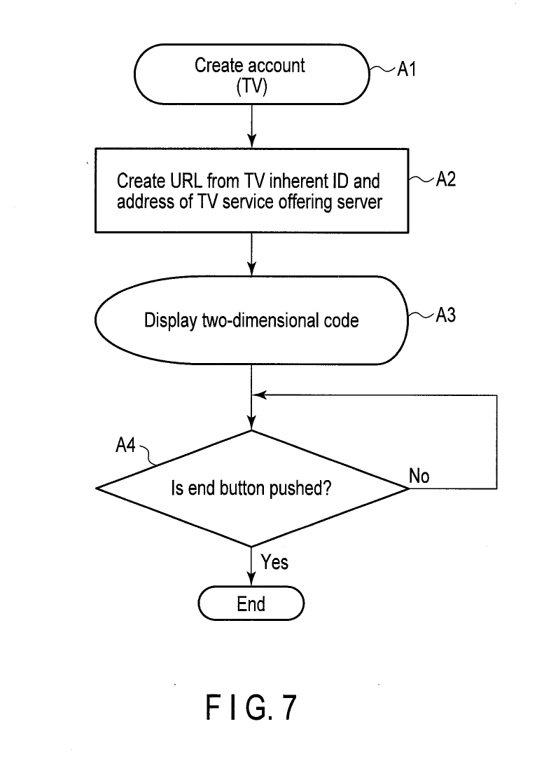

FIG. 7 shows a flow of operations to be performed when the television receiver 500 is started to create an account. When the television receiver 500 displays a menu, the entry “Account creation” is selected by a cursor based on an operation of a remote controller, and a decision button is pushed (step A1). As a result, the television receiver 500 creates a URL from device information indicating the television receiver and the address of a service offering server which is set in advance (step A2). Also, it creates a two-dimensional code including the URL and displays it on the screen. This playing operation ends when an end button is pushed (step A4).

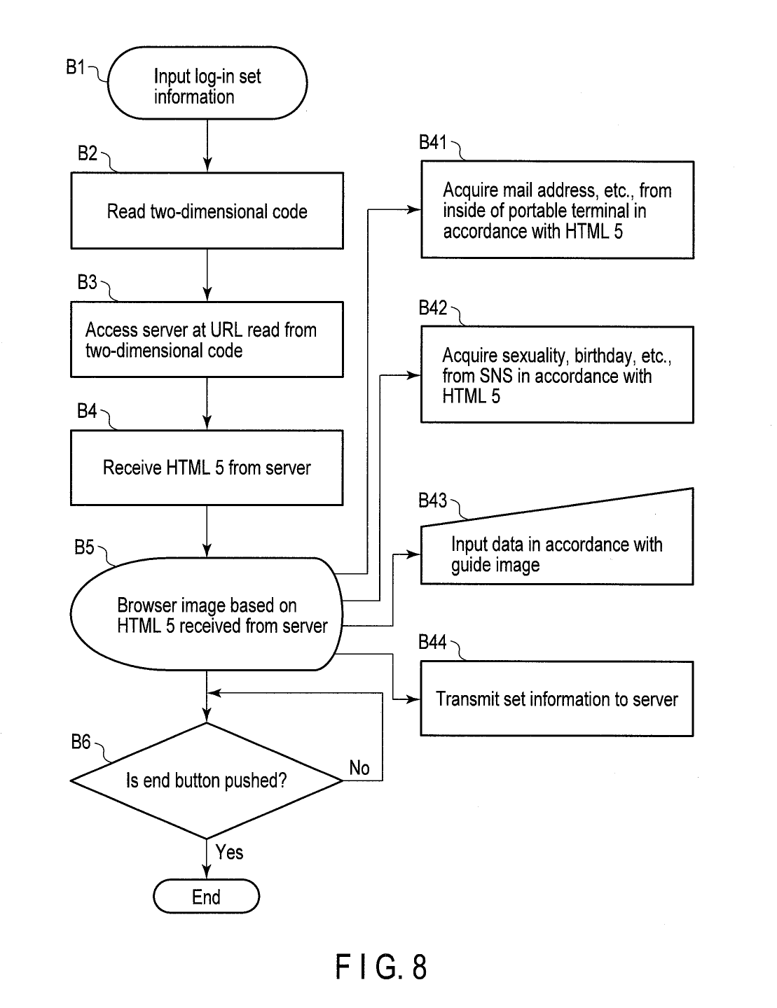

FIG. 8 shows a flow of operations to be performed when the portable terminal 700 is caused to enter an input mode for inputting log-in set information. In this flow, when a function menu of the portable terminal 700 is displayed, for example, the entry “inputting of log-in set information” is selected and determined (step B1); the portable terminal 700 becomes able to read a two-dimensional code; and the portable terminal 700 is operated by the user to make a camera read the two-dimensional code displayed by the television receiver 500 (step B2).

Next, the service offering server 900 is accessed at the URL read from the two-dimensional code (step B3). Since the HTML 5 is transmitted from the service offering server 900, it is received and a browser image is displayed in accordance with a code of the HTML 5 (steps B4 and B5).

In this state, in accordance with setting of an operation image by the user or a user's operation, information such as a mail address can also be acquired as log-in set information from the inside of the portable terminal. Furthermore, in accordance with setting of the operation image by the user or user's operation, the portable terminal can also obtain the date of birth and sexuality of the user as the log-in set information by using a social networking service (SNS). Those information items can be obtained in accordance with the operation or setting of the user with reference to the guide image (steps B41, B42 and B43).

With respect to acquisition of information such as a mail address, the date of birth and the sexuality of the user, if the user selects “Automatic acquisition”, the user does not need to input each of those information items to the portable terminal 700. For example, the date of birth and sexuality can be acquired from a network server such as Facebook (registered trademark) using an address or the like registered in the portable terminal.

After being input, necessary log-in set information is transmitted to the service offering server 900 (step B44). In the operation image at the portable terminal 700, when the end button is pushed, processing for inputting the log-in set information ends.

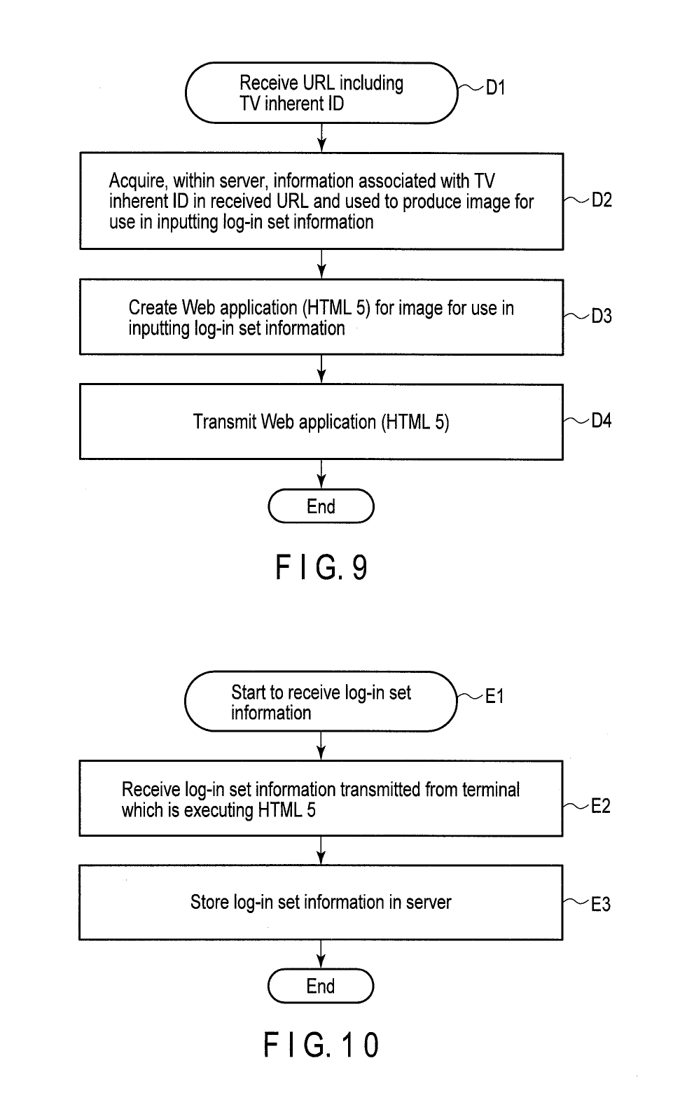

FIG. 9 shows an operating procedure of the service offering server 900, which is taken when the service offering server 900 is accessed from the portable terminal 700 based on an URL. First, a URL including device information (TV inherent ID) is received (step D1). Next, information which is associated with the received TV inherent information and used to produce an image for use in inputting the log-in set information is obtained within the server (step D2). Next, a Web application (HTML 5) for the image for use in inputting the log-in set information is created (step D3). Then, the created Web application (HTML 5) is transmitted to the portable terminal 700 (step D4).

FIG. 10 shows an operating procedure of the service offering server 900, which is taken when the service offering server 900 and the portable terminal 700 start to communicate with each other and log-in set information is transmitted from the portable terminal 700 to the service offering server 900. First, the service offering server 900 starts to receive log-in set information (step E1). It receives log-in set information from a terminal which is executing the HTML 5 (step E2). The received log-in set information is stored in the storage medium in the server (step D3).

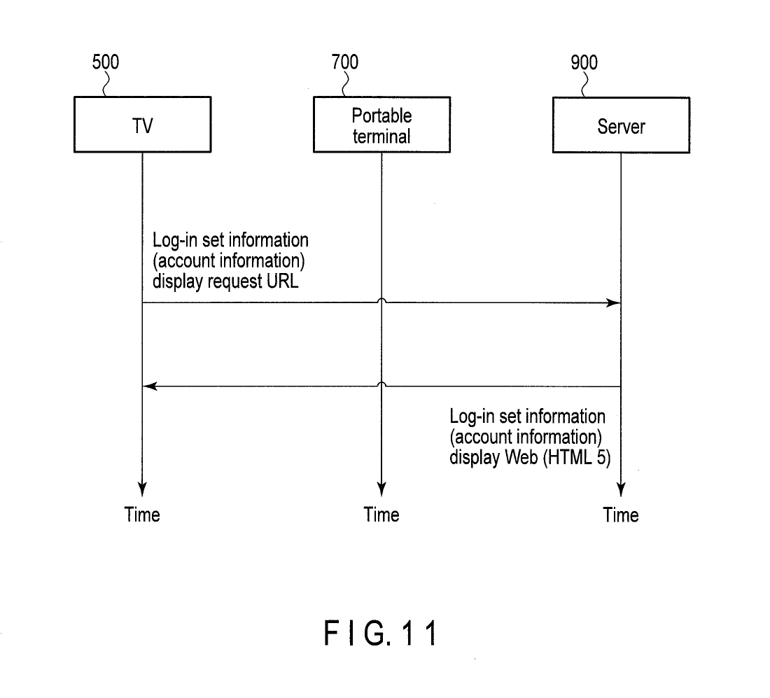

FIG. 11 indicates contents of communication between the television receiver 500 and the service offering server 900 along a temporal axis, which is performed when log-in set information for the television receiver 500 (which may also be referred to as account information) is confirmed at the television receiver 500, after the log-in set information is input to the service offering server 900 by the portable terminal 700.

At the television receiver 500, entries for confirming the log-in set information (or account information) are selected from a displayed menu.

To the service offering server 900, a display request for displaying the log-in set information (account information) can be made. At this time, the television receiver 500 can be operated, for example, by operating a specific operation button set in advance, with the television receiver 500 turned on. In response to the display request, the service offering server 900 transmits the log-in set information (account information) to the television receiver 500.

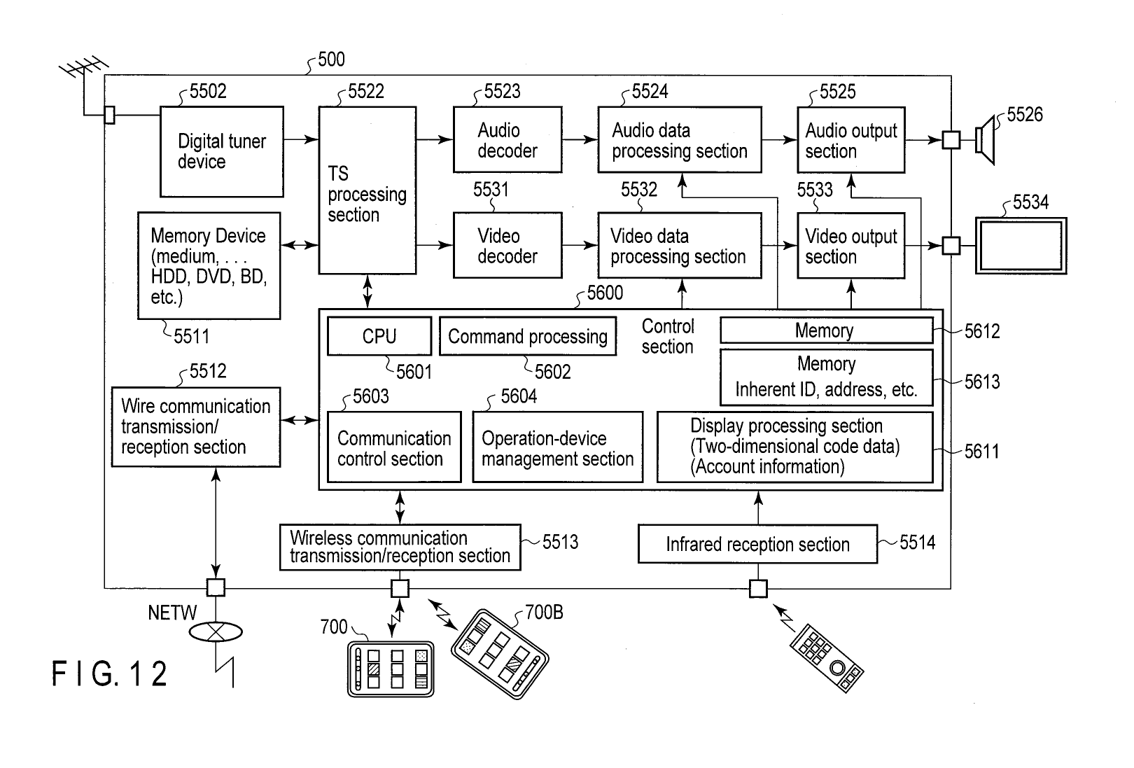

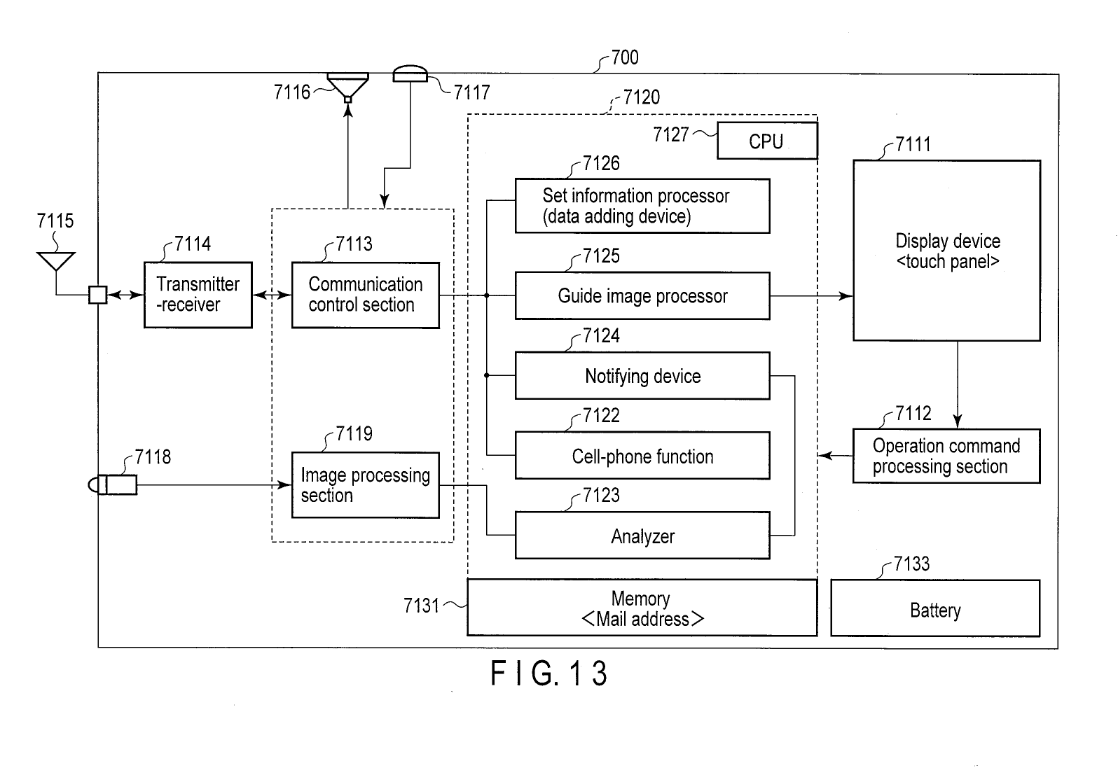

FIG. 12 is a block diagram of an example of a structure of the television receiver 500, and FIG. 13 is a block diagram of an example of a structure of the portable terminal 700.

The television receiver comprises a digital tuner device 5502 including a plurality of tuners configured to receive, e.g., a scrambled digital terrestrial broadcast signal. The digital tuner device 5502 may include, e.g., a tuner (not shown) for a BS/CS digital broadcast reception.

A signal of a broadcast program received by the tuner device 5502 is input to a TS processing section 5522, and transport streams (TSs) of a plurality of channels (CHs) are re-multiplied into a single TS. The TS includes packet trains of broadcast programs of channels. To each of packets of the channels, identification information for identifying an associated channel and packet is added. The TS is input to a memory device 5511. Also, in the TS input to the TS processing section 5522, a packet including control information is input to a control section 5600, and then processed.

As the memory device 5511, e.g., a hard disk driver and/or an optical disk recording/playback device is used. As the optical disk, a digital versatile disk (DVD), Blu-ray (registered trademark) disk (BD), or the like, is used.

The packet transmitted from the TS processing section 5522 to the control section 5600 includes, e.g., an Entitlement Control Message (ECM) which is encrypted information of the broadcast program, an Event Information Table (EIT) which is a table where event information such as the name of the program, performers and beginning time is written, and Electric Program Guide (EPG) information.

Video data included in the packet is encoded under, e.g., a Moving Picture Expert Group (MPEG) standard or an Advanced Video Coding (AVC) standard. Also, audio data in an audio packet is encoded under, e.g., a Pulse Code Modulation (PCM) standard, a Dolby (registered trademark) system or the MPEG standard.

Of packets separated from each other by the TS processing section 5522, a packet including audio data is input to an audio decoder 5523, and decoded based on an encoding standard. The audio data decoded in the audio decoder 5523 is subjected to synchronization processing, volume adjustment, etc., and supplied to an audio output section 5525. The audio output section 5525 executes stereo separation processing, etc., in accordance with a speaker system, and supplies an output to a speaker 5526.

Of the packets separated from each other by the TS processing section 5522, a packet including video data is input to a video decoder 5531. In the video decoder 5531, decoding is executed in accordance with an encoding standard. The video data decoded by the video decoder 5531 is subjected to synchronization processing, luminance adjustment, color adjustment, etc., by a video data processing section 5532. The output of the video data processing section 5532 is supplied to a video output section 5533. The video output section 5533 can multiply data, a figure, a program list, etc., from the control section 5600 into a main video signal. Also, the video output section 5533 sets a resolution, the number of lines, an aspect ratio, etc., for the output video signal, in accordance with a display device 5534, and outputs the video signal to the display device.

It should be noted that there is a case where an audio packet and a video packet of a pay program are encoded. Although a processing system for decoding encoded data with key information is present, it is omitted in the above case.

The control section 5600 comprises a central processing unit (CPU) 5601, an operation command processing section 5602, a communication control section 5603, an operation-device management section 5604, a display processing section 5611 and a memory 5612. It further comprises an electric program guide (EPG) data processing section, a record control section, etc., which are not shown.

The CPU 5601 adjusts an entire operation sequence of the control section 5600. The operation command processing section 5602 analyzes an operation command externally input, and can cause the television receiver 500 to reflect an operation according with the command. The operation-device management section 5604 can grasp and manage device identification data regarding devices such as the portable terminals 700 and 700B and a remote controller, which give an operation signal to the control section 5600.

The display processing section 5611 can overall control a video signal which is applied to displaying by the display device 5534 through the video output section 5533. Also, the display processing section 5611 can also execute adjustment processing of an image signal in resolution, display size, display area, etc. Furthermore, it can supply a video signal of a program list which is produced using EPG data, a menu video signal produced in the control section 5600 in accordance with the operation signal, etc., to the video output section 5533.

A memory 5612 can store various kinds of data and applications to be stored in the control section 5600. The memory 5612, as described above with reference to FIG. 11, can also be used as a data storage portion when account information is displayed.

A memory 5613 is a nonvolatile memory, and stores device information (TV inherent ID) and address data necessary to produce a two-dimensional code.

The device information and address data stored in the memory 5613 are read by the display processing section 5611, and used to acquire an image of a two-dimensional code as shown in FIG. 2. The image of the two-dimensional code produced by the display processing section 5611 is displayed by the display device 5534 through the video output section 553.

Furthermore, as explained above with reference to FIG. 11, the display processing section 5611 operates also in order to fetch account information from the service offering server 900, and causes it to be displayed at the display device 5534.

The communication control section 5603 can fetch an operation command, data, content, etc. by communicating with an external device. The fetched content and data can be stored in, e.g., the memory device 5511 or the memory 5612. The communication control section 5603 can transmit data, content, etc., from the television receiver 500 to an external device.

Also, the communication control section 5603 is connected to a wireless communication transmission/reception section 5513 (which may be referred to as a communicator 5513) and a wire communication transmission/reception section 5512. The wire communication transmission/reception section 5512 (which may be referred to as a communicator 5512) can transmit and receive data to and from a remote server or a home server through the Internet. The wireless communication transmission/reception section 5513 can transmit and receive data to and from the portable terminals 700 and 700B, and is applied to short-distance communication. Furthermore, the television receiver 500 can also receive an operation signal from a remote controller through an infrared reception section 5514.

The portable terminals 700 and 700B can remotely control the television receiver 500. The portable terminals 700 and 700B can access a server through the Internet, a base station not shown, or the like. They can also download various kinds of applications and game software, to say nothing of content provided by the server, and transfer them to the control section 5600 through the wireless communication transmission/reception section 5513.

Also, the portable terminals 700 and 700B can transfer information (e.g., a network address, mail address or address of a web server) for acquiring content to the control section 5600 through the wireless communication transmission/reception section 5513.

In the case where content, an application or game software is transferred from the portable terminal 700 or 700B, the communication control section 5603 of the control section 5600 operates. After receiving the content, the communication control section 5603 stores the content in the memory 5612. The content may be stored in the memory device 5511 automatically or in response to the operation command. After receiving the content, the memory device 5511 can cause the content to be stored in, e.g., a hard disk. In the hard disk, the content is managed as a content file.

A menu video signal, a program-list video signal, etc., which are applied to displaying, are stored or managed by the display processing section 5611. In the case where a menu or a program list is displayed, menu image data or program-list video signal is read from a data storage section (memory or hard disk) based on control processing of the display processing section 6511, and supplied to the video output section 5533. Thereby, a menu image or a program-list image is displayed by the display device 5534.

The menu video signal, the program-list video signal, etc., can also be transmitted to the portable terminal 700 or 700B. If the portable terminal 700 or 700B requests the menu video signal and program-list video signal, the display processing section 5611 can transmit the menu video signal and the program-list video signal to the portable terminal 700 or 700B.

The portable terminal 700 or 700B can cause the menu video signal or the program-list video signal to be displayed on a screen of a touch panel, and the user can give an operation command signal to the television receiver by touching an operation button displayed on the screen of the touch panel.

FIG. 13 shows an example of a structure of the portable terminal 700. A display device 7111 can operate as a video display section and also as a touch panel.

While a menu image is being displayed, when the user touches a desired entry, an operation input thereof is recognized by an operation command processing section 7112. For example, if the touch operation is an operation input for selecting a telephone function, the portable terminal 700 enters a cell phone mode.

In the cell phone mode, the display device 7111 displays an operation image for use in dialing input or a phone-number list, names of other parties or persons, etc., which are registered in advance. With the operation image, the user selects a desired party or person or dialing input thereof. A cell-phone function section 7122 in a system control section (or processor) 7120 transmits a call signal of the party at the other end of communication through a communication control section 7113, a transceiver 7114 and an antenna 7115.

When connection of a communications line between the portable terminal 700 and the party at the other end of communication is established, a signal from the party at the other end is decoded through the transceiver 7114 and the communication control section 7113. Then, voice data is output from a speaker 7116. Also, voice data is transmitted to the communication control section 7113 through a microphone 7117. It is then transmitted as transmission data to the party at the other end through the transceiver 7114.

A memory 7131 is used to store data or an application. Also, the memory 7131 stores a mail address of the portable telephone 700, etc. As the memory 7131, a storage medium such as a readable/writable random-access memory, a nonvolatile memory or a disk, can be applied. 713 denotes a battery, which can be charged.

Furthermore, the portable terminal 700 comprises an image processing section 7128 and a camera 7118 serving as an image capture. As explained above with reference to FIG. 8, when an input mode for inputting log-in set information is started, the portable terminal 700 becomes able to read the two-dimensional code. When the user makes the camera 2118 face the two-dimensional code, the display device 7111 displays the two-dimensional code. Also, when the user operates a fetch button, the two-dimensional code is fetched into the image processing section 7128 through the camera 7118, and image data is analyzed by an analyzer 7123. The analyzer 7123 analyzes the two-dimensional code to make a URL. When the user operates the transmission button of the touch panel, the service offering server 900 is accessed based on the URL, and such operations as explained with reference to FIGS. 1-10 are started.

The analyzer 7123 supplies analyzed information to a notifying device 7124. The notifying device 7124 establishes communications with the service offering server 900 through the transceiver 7114, using an address in the two-dimensional code. The notifying device 7124 and the transceiver 7114 may be referred to as a communicator. It sends the TV inherent ID (device information) to the service offering server 900. As a result, HTML 5 is sent from the service offering server 900, and thus a guide image processor 7125 sets an environment in which set necessary for an electronic apparatus (the television receiver 500) having the device information to log in to the predetermined server (the service offering server 900) can be input. That is, the guide image processor 7125 makes the display device 7111 display a guide image based on information received from the predetermined server through the transceiver 7114. The user inputs log-in set information through the guide image. A set information processor 7126 supplies the input log-in set information to the predetermined server through the transceiver 7114 in order for the log-in set information to be registered in the predetermined server. A central processing unit (CPU) 7127 can adjust the operating timing of each of blocks.

In addition, the portable terminal 700 can also download content or an application through the Internet. Furthermore, it can transfer the downloaded content or application to the television receiver as shown in, e.g., FIG. 1, based on control processing of a data transfer section (not shown). In this case, the portable terminal 500 functions as a relay in appearance. Also, in this case, the short-distance communication may be performed through the antenna, the transceiver and a communication control section not shown.

It is shown that the system control section 7120 of the portable terminal 700 is divided into a plurality of blocks; however, needless to say, functions of the blocks may be achieved by software using codes of programs recorded in a computer-readable recording medium. Therefore, the functional blocks of the system control section 7120 can be indicated as steps of a method to be carried out by a program or as steps to be carried out in a program.

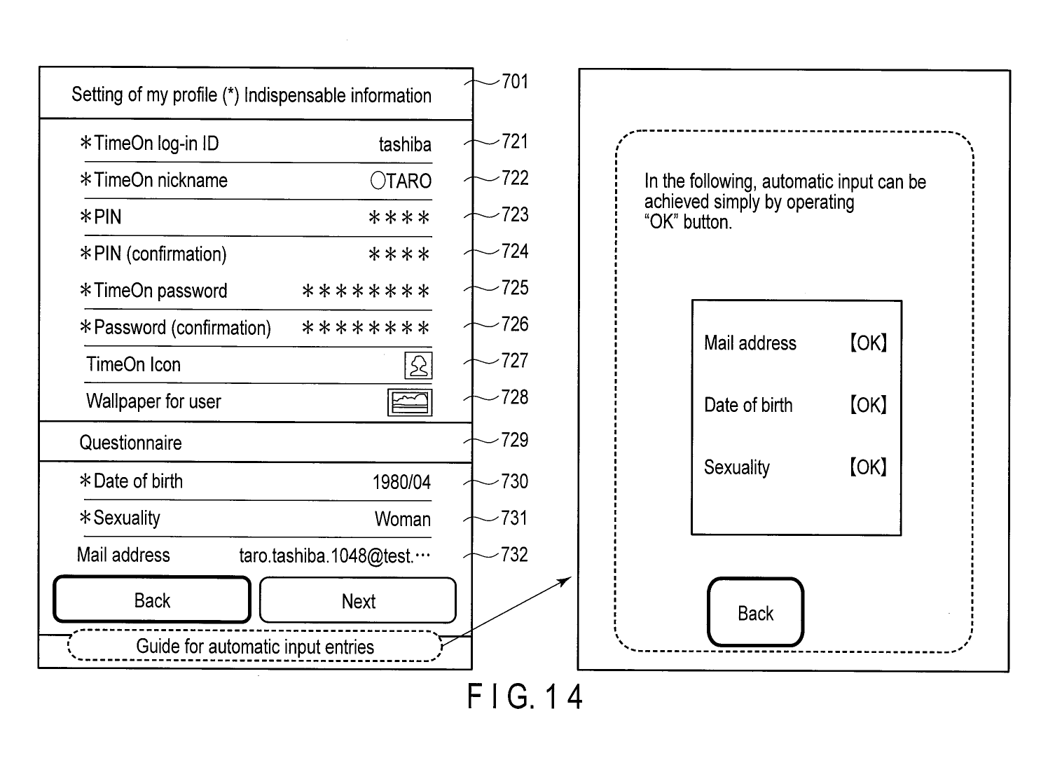

As shown in FIG. 14, in the portable terminal 700, when log-in set information items are being input, there is a case where a guide for automatic input entries is displayed. For example, when a password is input, e.g., the item “guide for automatic input entries” is displayed. When this item is touched by the user, the image displayed on the screen of the portable terminal is changed, and such an image as shown in right part of FIG. 14 is displayed.

In the image as shown in the right part of FIG. 14, for example, the message “In the following, automatic input can be achieved simply by operating “OK” button.” is obtained. As log-in set information items which can be automatically input, for example, “mail address”, “date of birth (birthday)”, “sexuality”, etc., are present.

To be more specific, when the user touches an “OK” button set for an entry for which the user wants to do input as automatic input, an associated set information item is automatically input. In an image as shown in left part of the figure, with respect to entries 730, 731 and 732, examples of automatically input “date of birth (birthday)”, “sexuality” and “mail address” are shown.

The item “guide for automatic input entries” can be displayed at various timings. For example, when birthday information or the like is obtained from a social networking service, e.g., Facebook (registered trademark), there is a possibility that it may become necessary to input a password to access Facebook. At this time, when the password is input, the above item is displayed. Furthermore, since a portable terminal is applied on the premise that it is used only by a certain person, it can also be set that if a password for a SNS, and access succeeds, a request for inputting a password is not made again. In such a case, for example, the above item may be displayed at a corner of a displayed image when an operation is started. Also, it can be set that when the above item is selected in such a case as described above, for example, login ID, nickname, etc., information set in advance in the portable terminal are automatically set as log-in set information items.

The guide image processor 7125, which displays the above guide for automatic input entries, can be defined as a processor which can cause the display device to display an inquiry message to determine whether or not to automatically add to the log-in set information, internal data stored in advance in a memory of the portable terminal.

In the case where the above “mail address” is automatically set as a log-in set information item, the set information processor 7126 is set to include a first data adding device configured to add internal data stored in advance in the memory 7131 in the portable terminal.

Furthermore, in the case where the above “date of birth (birthday)”, “sexually”, etc., are automatically set, the set information processor 7126 is set to include a second data adding device configured to add to the log-in set information, user inherent information fetched from an external server (e.g., Facebook (registered trademark)) through the transceiver.

In the above system, it is possible to very easily set log-in set information for a TV to the server.

It should be noted that the portable terminal 700 reads a two-dimensional code from an image displayed on the screen of the television receiver 500, as a first operation to start to input log-in set information; however, as the two-dimensional code, a two-dimensional code printed on an instruction book added as an appendix to the television receiver 500 may be used.

In the above explanation, it is described that each of “date of birth (birthday)”, “sexuality” and “mail address” can be automatically set by operating the “OK” button. However, automatic setting of the data item “mail address” present in the portable terminal may be specified in such a way as to be distinguished from automatic setting of the data items “date of birth (birthday)” and “sexuality” which are present outside the portable terminal.

In this case, the guide image processor 7125 causes a first inquiry message and a second inquiry message to be distinguishably displayed by the display device 7111. The first inquiry message is a message for determining whether to automatically add internal data stored in advance in the memory of the portable terminal to the log-in set information, and the second inquiry message is a message for determining whether to automatically fetch user inherent information from an external server, and add it.

Furthermore, the above embodiment can be applied not only to the case where network use information is set, but the case where the following information is set in the television receiver 500.

In the system, with the two-dimensional code, the portable terminal 500 can establish communications with the service offering server 900. The portable terminal 500 transmits data to the service offering server 900. This transmitted data is data closely associated with an operation of the electronic apparatus (the television receiver 500) having device information included in the two-dimensional code.

Therefore, as the above closely associated data, adjustment data of the television receiver 500. This is because that the television receiver 500 has address information on the service offering server 900, and can access the service offering server 900 to acquire the adjustment data.

As adjustment data items, channel set data, color adjustment data, luminance adjustment data, image-quality set data, brightness set data, etc. regarding the television receiver 500 are present. In addition, data on setting of the screen which is performed when the television receiver 500 is connected to a network and data on setting of conditions or time which is performed when it enters a power saving state are present.

Therefore, when “next” buttons are successively operated, input images for inputting the above adjustment data items are successively displayed. Then, when each of the adjustment data items is input, and a “set and transmission” button is pushed, each adjustment data item is transmitted to the service offering server.

When the television receiver 500 is started, if “menu display” is selected by an operation by the user, a menu is displayed, which includes the entry “initial setting”. If “initial setting” is selected, “manually input setting” and “automatic setting” appear. If “automatic setting” is selected, the television receiver 500 automatically accesses the service offering server 900, acquires the above adjustment data, and performs self-setting based on the adjustment data.

In the above explanation, it is described that in the case where log-in set information is input, information for causing, e.g., a single user, to log in is input. However, in the above embodiment, log-in set information to be input is not limited to log-in set information on a single user; that is, it can also be input as log-in set information regarding, e.g., a family.

This is because in addition to the case where a television receiver or a personal computer is used by a single user, there is a case where it is shared among members of a family.

Therefore, in the portable terminal 700, when such a browser image as shown in FIG. 3 is displayed, it includes message entries such as message entries “Is log-in set information input as one for personal use?”, “Is log-in set information input as one for family use?” and “Is log-in set information input as one for group use?”. The user selects a desired one of the message entries, and inputs log-in set information.

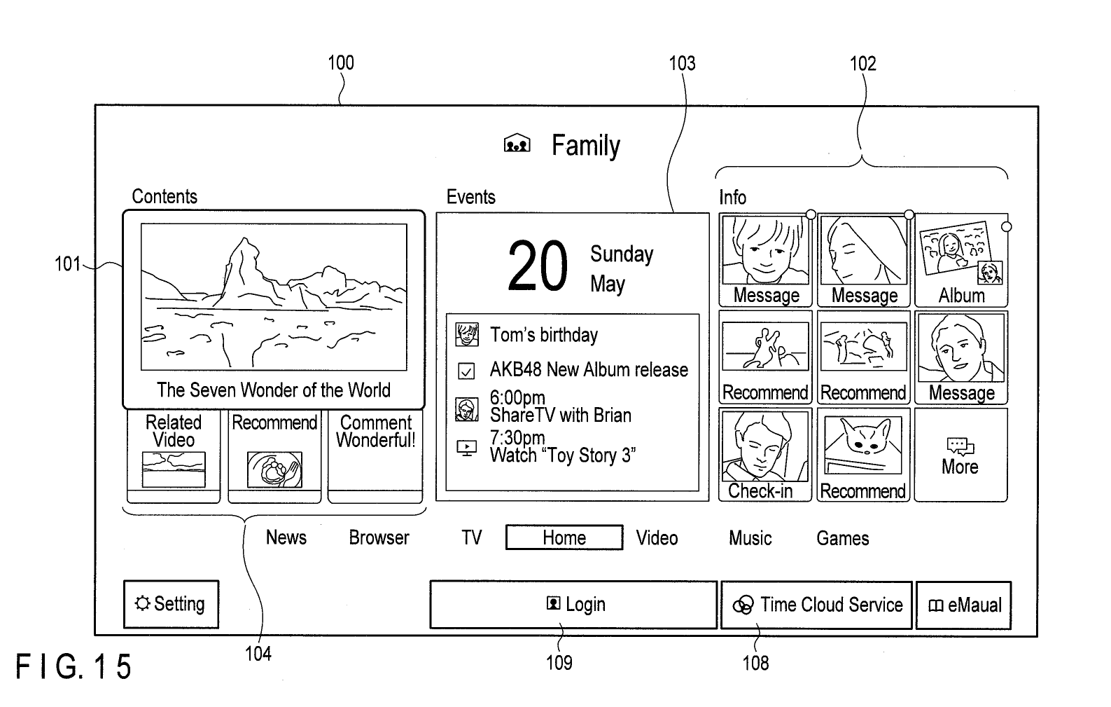

FIG. 15 shows an image 100 displayed when the television receiver 500 is connected with the service offering server 900 and logs in thereto with family ID. In the login, if a decision button is pushed after a log-in operation area 109 is selected with a cursor by operating the remote controller or portable terminal, a blank field for inputting a password is displayed in the log-in operation area 109. When inputting a password and pushing a decision button, the user formally logs in to the service offering server 900.

In a display area 102, guide images for various kinds of transmission/reception boxes are displayed to receive recommend data and information from a family or friend. As the transmission/reception boxes, transmission/reception boxes for outlook, mail, message and recommend data are present. In each of image frames indicating the transmission/reception boxes, as explained with respect to FIG. 4, a desired icon image and desired wall paper selected from an image file are indicated along with a guide image.

In the case where a message or recommend data is sent to a transmission/reception box, an associated guide image is indicated by, for example, addition of a circle mark, changing of the color of the frame, or repeatedly changing of the luminance of the frame. Furthermore, if a plurality of recommend data is sent to a transmission/reception box, an associated guide image may be indicated, with a plurality of circle marks or numbers added thereto.

The above transmission/reception boxes (as indicated in the display area 102 in FIG. 15) can be applied to, e.g., communication between members of a family or that between a member of a family and a friend. Also, there is a case where an album is sent from a friend or a brother living in the distance, and also a case where recommend data is sent from a friend. As the recommend data, for example, recommended program information and recommended shopping information are present. Also, information regarding a recommended scene, a recommended performer or the like is present.

Furthermore, a plurality of guide images for a function system are displayed in an area 104 located on a lower side of an area 101. These guide images are used in the case where the user operates the television receiver 500 in association with video played back in the area 101 (which may be video of a program being received or video played back from a record medium). To be more specific, the guide images are used in the following cases: for example, in the case where the user communicates with a server (another user) in association with video played back in the area 101, the user selects any of the guide images, and operates a decision button. Then, recommend data, questionnaire data or the like associated with video being played back can be transmitted to the server.

<Example of Use of Guide Images in Display Area 102>

The user can locate the cursor at a desired guide image (for example, a guide image for message from mother to her child) by controlling, e.g., the remote controller (there is also a case where the portable terminal has a function of a remote controller). The guide images may be referred to as operation buttons. The cursor is displayed as, e.g., a frame surrounding a guide image. In the case where the cursor is located at a desired guide image, if a decision button of the remote controller is pushed (clicked), a transmission/reception box associated with the guide image is opened, and for example, a message is displayed. The message can be displayed in, e.g., the entire or half of the area 102.

Also, the user can open a transmission/reception box of recommend data by operating the remote controller. There is a case where for example, the recommend data is recommended shopping information or recommended program information indicating a recommended program, which is sent from a friend. In this case, if the user takes interest in the recommended program, and wishes to view the program, when the user locates the cursor at a displayed selection button for the recommend program, and pushes a decision button, the television receiver 500 can automatically start to play back the program. In this case, it may be set that video of the program is displayed in a small area, and then, when the user pushes the decision button, it is displayed in a large area.

Also, the transmission/reception boxes can be each used in the case where a message is sent to the portable terminal or a transmission/reception box of the party at the other end of communication. The recommended program information is displayed as the name of a title, a scene of a program, or the name or image of a performer. Also, as the recommended program information, a content server address and information regarding a broadcast channel number, a broadcasting date and hour, a performer prologue, etc., are present.

In the above case, as methods of acquiring program content with the television receiver 500, there are provided a first method of acquiring program content by driving a record device connected to the television receiver 500 and a second method of acquiring program content by downloading it from a content server through the Internet. In the first method, a program list searching function for a program or programs recorded in the record device is operated. In the second method, an address of the content server which is included in the recommended program information is utilized.

Furthermore, there is a case where the recommended program information includes data processed to cause the user to easily obtain the program content. To be more specific, a recommended program recommended by a friend is uploaded from a device of the friend to the server, and in the server, it is processed to be usable by the user. This processing is executed for the reason that there is a case where broadcast channel numbers, time slots on the broadcasting schedule, etc., vary from one area to another. Therefore, in order for the user to easily search for and obtain a program identical to that recommended by the friend, program information is provided to the user after being processed (with respect to, e.g., broadcast channel numbers, time slots on the broadcasting schedule). In addition, there is a method of acquiring recommended program information from calendar information.

Also, it is possible to send, using guide images in the display area 102, a mail, a short message or the like to a member of a family or a friend registered in a management device configured to manage the guide images. In this case, the friend is a mutual friend of the members of the family. Information regarding the mutual friend and another family the members of which are mutual friends of the above former family is recognized and registered in a management device for the former family, which stores and manages data on a guide image for the former family.

<Example of Use of Guide Images in Area 104>

For example, suppose a program being currently viewed (displayed in the area 101) is a dram, and the user takes a fancy to a certain scene of the dram or the dram contains a scene in which a favorite performer appears. In such a case, the user operates the remote controller to select any of recommend guide images, and push a decision button. As a result, program information regarding the program being viewed by the user is uploaded to the server as attention (or notice) program information. The server can use this attention program information as material for producing recommend program information or as information for producing a tag list of the program. Also, since the server receives attention program information regarding various kinds of programs, which are transmitted from a number of viewers, it can execute statistical processing based on the attention program information. Due to the statistical processing, a program information list of programs listed in descending order in rating can be prepared.

Furthermore, the user can select a guide image for making a comment and push a decision button by operating the remote controller. In response to this operation, an image for inputting a short message regarding the program being viewed by the user (displayed in the area 101) appears, and enables the user to input a message. The message can be input from, e.g., the remote controller or a keyboard of the portable terminal.

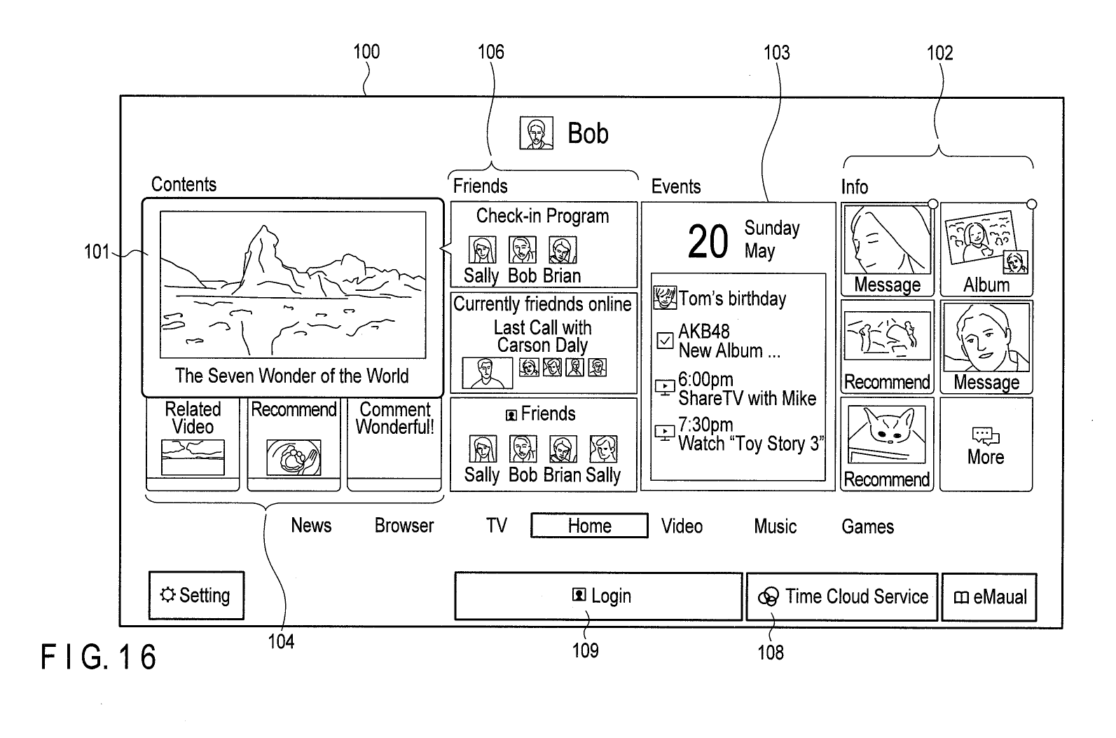

FIG. 16 shows an image 100 displayed when the television receiver 500 is connected with a net, and logs in with person ID. In the image 100, a display area 106 for guide images to foster communications with a friend is present between the area 101 and area 103. In the display area 106, for example, three types of guide images are present. In the upper one (Check-in to Program) of the guide images, a list of other persons (friends) who are viewing a program at the same time as the user is displayed. In the intermediate one (Currently friends online) of the guide images, a list of other persons whose television receivers 500 are connected to the network, and who are viewing a program or programs different from that being viewed by the user is displayed. In the lower one (Friends) of the guide images, a list of other persons whose television receivers 500 are not connected to the network is displayed. Logged-in state of television receivers 500 are periodically sent to the server. Therefore, the server can distinguish users who are in a non-connected state, users who are in a connected state, and users who are in a connected state and viewing the same program, from each other. The server monitors statuses of a plurality of users. Thus, the television receiver 500 can provide such three types of guide images as shown in the display area 106.

<Example of Use of Guide Images in Display Area 106>

For example, there is a case where in a dram being currently viewed, if a son B of a friend A appears, the user will want to make it known to the friend A or a family member of the friend A. Also, there is a case where if the friend A searches for a stray dog C, and the user views news concerning the stray dog C, the user will want to make it known to the friend A or a family member of the friend A. In such a case, the user can utilize a guide image displayed in the area 106.

To be more specific, by operating the remote controller, the user can select with the cursor a guide image in which a desired friend is indicated, and push a decision button. Thereby, the image to be displayed can be shifted to an image for enabling a message to be sent to the above friend.

Also, in the above communication, a guide image displayed in the display area 102 and containing a recommend or a written message can be applied. The user can select with the cursor a guide image in which a desired image is displayed, and push a decision button, by operating the remote controller. Thereby, a message directed to a family or a person registered in a transmission/reception box of the selected guide image can also be transmitted. The guide images in the display area 106 can be used mainly for private communication.

<Example of Use of Guide Image in Display Area 103>

In this guide image, a calendar is displayed, and the title of an event or schedule of the day is simply displayed. If the user wishes to know detailed information regarding the event or schedule, the detailed information is displayed by selecting the title of the event or schedule with the cursor, and clicking it. The detailed information can be browsed based on, e.g., addresses of URLs.

In the above calendar, a schedule of the user, etc., can be written. When a display area of the calendar is selected with the cursor, usage entries of the calendar are displayed. When a schedule write entry is selected, it is possible to input a schedule by the remote controller or the portable terminal.

<Cloud Service Button>

In the image 100, a button 108, which is referred to as, e.g., “(Time cloud Service)”, is indicated (its name and position are not limited to those of the embodiment).

Suppose while viewing content displayed in the area 101, the user selects the button 108 of the cloud service button using the cursor, and gives an instruction for cloud service. Thereby, an application for cloud service in the television receiver can be started. If the cloud service is started, content to be viewed and a service menu associated with the content are provided from a time cloud server (may be from the service offering server 900), and the service menu can be displayed in a menu list. Then, in accordance with the displayed state, the associated service menu to be displayed can be switched. It should be noted that various cloud services are present, and can be variously developed.

Connection to the cloud service server may be executed by operating a specific button of the terminal or the remote controller.

As described above, the terminal according to the embodiment comprises an image capture (which may be referred to as image pickup means or an image pickup section) configured to optically image an object, and a processor (which may be referred to as a processing section or processing means) configured to acquire device information and a first address of a first server through the image capture. Furthermore, it further comprises a display controller (which may be referred to as a display control section or display control means) configured to display a guide image based on information received from the first server through the communicator, the guide image being provided as an image for enabling set information to be input, the set information being used by an electronic apparatus having the device information to log in to the first server. The processor supplies log-in set information input based on the guide image to the first server through the communicator in order for the log-in set information to be registered in the first server.

The processor can add internal data stored in a memory in the terminal to the log-in set information before acquiring information through the image capture.

Furthermore, the processor can also add user inherent information fetched from an external server through the transmission/reception device to the log-in set information.

The display controller causes the display device to display an inquiry message for determining whether or not to automatically add the internal data stored in advance in the memory in the terminal to the log-in set information. Furthermore, the display controller can also cause the display device to display an inquiry message for determining whether or not to automatically fetch user inherent information from the external server, and add the user inherent information to the log-in set information. It should be noted that the inquiry message may be displayed by the display device at least when a password is input as the log-in set information.

The display controller can cause the display device to display an input image for use in inputting adjustment data of the electronic apparatus, and the processor can supply the adjustment data input based on the input image to the first server through the transmission/reception device.

Needless to say, even if “device” and “block” in the above explanation are replaced with “means”, “device” and “module”, they can be applied to the embodiment. Furthermore, in the “Claims” section, even if a plurality of elements into which each of structural elements is divided are expressed, and also even if a combination of a plurality of elements is expressed as a structural element, those elements are covered in the embodiment. Furthermore, in the case where claims are recited as method claims, they are method claims corresponding to device claims recited in the application.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A terminal comprising:
an image capture configured to optically image an object displayed by a display device;
a processor configured to acquire device information of the display device and a first address of a first server through the image capture;
a communicator configured to send the device information to the first server using the first address; and
a display controller configured to display a guide image based on information received from the first server, the guide image used for inputting set information to be used by the display device to log in to the first server,
wherein the communicator is configured to send the set information to be registered to the first server, and the set information is input by using the guide image.

2. The terminal of claim 1, wherein the processor adds internal data stored in a memory provided in the terminal to the log-in set information before acquiring information by use of the image capture.

3. The terminal of claim 1, wherein the processor adds user inherent information fetched from an external server through the communicator to the log-in set information.

4. The terminal of claim 1, wherein the display controller causes a display device to display an inquiry message for determining whether or not automatically add internal data stored in advance in a memory provided in the terminal to the log-in set information.

5. The terminal of claim 1, wherein the display controller causes a display device to display an inquiry message for determining whether or not to automatically add user inherent information from an external server to the log-in set information.

6. The terminal of claim 5, wherein the inquiry message is displayed by the display device in connection with starting of an input image for inputting at least the log-in set information.

7. The terminal of claim 1, wherein:
the display controller causes a display device to display an input image for inputting adjustment data regarding the electronic apparatus; and
the processor supplies the adjustment data input using the input image to the first server through the communicator.

8. A log-in set information inputting method of an electronic apparatus which comprises a transceiver, an image capture configured to optically image an object, a processor and a display controller, comprising causing the processor to:
acquire device information and a first address of a first server through the image capture;
send the device information to the first server using the first address of the analyzed two-dimensional code, through the transmitter-receiver;
receive set information, and causes the display controller to output a guide image based on information received from the first server through the transceiver, the set information being used by an electronic apparatus having the device information to log in to the first server; and
supply the log-in set information to be registered to the first server thorough the transceiver, the log-in set information be input by using the guide image.

9. The log-in set information inputting method of claim 8, wherein to the log-in set information, internal data stored in advance in a memory provided in the terminal to the log-in set information is added, and/or user inherent information fetched from an external server though the transceiver is added.

10. The log-in set information inputting method of claim 8, wherein the display controller causes a display device to display a first inquiry message for determining whether or not automatically add internal data stored in advance in a memory provided in the terminal to the log-in set information, and/or causes the display device to display a second inquiry message for determining whether or not automatically fetch user inherent information from an external server and add the user inherent information to the log-in set information.

11. The log-in set information inputting method of claim 8, wherein the two-dimensional code is read from an instruction book of the electronic apparatus.

12. A computer-readable information storage medium storing program commands to be given to a transceiver, an image capture configured to optically image an object, a processor and a display controller,
wherein the program commands comprise:
a command to acquire device information and a first address of a first server through the image capture;
a command to send the device information to the first server using the first address of the analyzed two-dimensional code, through the transceiver,
a command to fetch set information and cause the display controller to display a guide image based on information received from the first server through the transceiver, the set information being used by an electronic apparatus having the device information to log in to the first server; and
a command to supply the log-in set information to be registered to the first server thorough the transceiver, the log-in set information be input by using the guide image.

13. The computer-readable information storage medium of claim 12, wherein the program commands further comprise a command to add internal data stored in advance in a memory provided in the terminal to the log-in set information, and/or a command to add user inherent information fetched form an external device through the transceiver to the log-in set information.

14. The computer-readable information storage medium of claim 12, wherein the program commands further comprise a command to cause a display device to display a first inquiry for determining whether or not to automatically add internal data stored in advance in a memory provided in a terminal to the log-in set information, and/or a command to cause the display device to display a second inquiry for determining whether or not automatically fetch user inherent information from an external server, and add the user inherent information to the log-in set information.

15. An electronic apparatus in which a two-dimensional code is read by a terminal which comprises: a transceiver; an image capture configured to optically image an object; a display device; an analyzer configured to read a two-dimensional code including device information and an address of a first server through the image capture, and analyze the two-dimensional code; a notifying device configured to establish communications with the first server through the transceiver, using the address in the two-dimensional code, and send the device information to the first server; a display controller configured to cause the display device to display a guide image based on information received from the first server through the transceiver to enable set information to be input, the set information being necessary for an electronic apparatus having the device information to log in to the first server; and a processor configured to supply log-in set information to be registered to the first server thorough the transceiver, the log-in set information be input by using the guide image, wherein the display device is configured to display the two-dimensional code including the device information and the address of the first server.
